(19) United States
(12) Patent Application Publication
(10) Pub. No.: US 2010/0106519 A1
(43) Pub. Date: Apr. 29, 2010

(54) LOW COST SYSTEM FOR REMOTE PATIENT AUDIO/VIDEO CONTENT DELIVERY

(75) Inventors: Gilbert Lemke, Los Gatos, CA (US); David Moberly, Palo Alto, CA (US); James M. Rueter, Naples, FL (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/529,554

(22) PCT Filed: Feb. 15, 2008
(86) PCT No.: PCT/IB08/50561

§ 371 Date: Sep. 2, 2009

Related U.S. Application Data
(60) Provisional application No. 60/893,739, filed on Mar. 8, 2007.

(51) Int. Cl. G06F 21/00; G06Q 50/00; G06F 3/048; H04N 7/173; G06F 3/00

(52) U.S. Cl. 705/2; 715/764; 725/87; 715/716; 380/255

(57) ABSTRACT

When providing a cost-efficient remote patient monitoring and/or education system, a home-end device (HED) (12) is coupled to a central server (14) using a communication link over PSTN line or the like. Educational audio/video (AN) content is delivered to the patient on a storage medium (18) for playback via a media player (20, 38) in the HED (12). The server (14) provides keys to the HED (12) at predefined times to permit the HED (12) to display a scheduled video segment stored on the storage medium (18) to the patient at the scheduled time. The patient answers survey questions, and patient responses are transmitted over the PSTN line to the server for review by a clinician or doctor, who may be present at the server (14) or at a remote terminal (16) coupled to the server (14). Additionally, one or more patient monitoring devices (22) are coupled to the HED (12), and the HED (12) transmits monitored conditions of the patient to the central server (14) over the communication link for evaluation by the clinician or doctor.

The present application finds particular application in remote communication of healthcare information, education, and monitoring of the health status for a patient, particularly involving user-friendly installation of networking systems at a patient's location, such as a patient's residence, to facilitate connecting a user to a centralized server for service. However, it will be appreciated that the described technique(s) may also find application in other remote user systems, other health status monitoring techniques, or other communication techniques.

Home telemonitoring and information systems leverage consumer electronics and broadband technologies to implement a secure, personalized healthcare platform connecting patients and their care providers, thereby enabling new care models. For example, healthcare organizations can use such systems to manage patients with chronic diseases. Some systems can use vital sign measurement devices in the patient's home to obtain objective, quantifiable data on the patient's medical condition. Additionally, short surveys or questionnaires can be presented to the patient to obtain subjective data on the patient's medical condition and to test the patient's knowledge of healthcare issues. A variety of techniques can be employed to assist the patient in modifying his or her behavior to help treat the patient's medical condition. For example, custom video content can be presented on the patient's television in his or her home using an Internet protocol set top box connected to a broadband (e.g., cable, DSL, satellite) Internet connection.

However, conventional solutions have drawbacks. One problem is related to the costs of equipment, maintaining the broadband connection, and installing the equipment. Another problem with conventional solutions is that broadband connections to the home, although fairly common, are not readily available in some geographical areas. The high data rates available over broadband are typically only required for video transfer, not for other functions such as vital sign device data, messages, surveys, quizzes, etc. Thus, there is an unmet need in the art for systems and methods that facilitate streamlining remote patient monitoring systems to reduce patient confusion during setup and/or use, and to mitigate costs associated with providing unnecessary functionality that the patient does not need or use.

In accordance with one aspect, a system for remotely monitoring a patient includes a home-end device HED that periodically connects to a healthcare service provider server over a communication link and receives at least one decryption key. The system further includes a media player that receives a storage medium containing encrypted audio/video (A/V) content, a scheduled portion of which is unlocked by the at least one decryption key, and a power cable connection.

In accordance with another aspect, a method for providing a remote patient healthcare monitoring and education system includes instructing the patient to connect an HED to a telephone line and a power source, physically providing encrypted healthcare-related media content to a patient on a physical medium, instructing the patient to insert the media content physical medium into a media player associated with the HED, and generating a communication link between the HED and a centralized server over the telephone line. The method additionally includes providing one or more keys that unlock a scheduled portion of the media content to the HED and displaying the scheduled portion of the media content to the patient.

One advantage is that overall system cost is reduced.

Another advantage resides in simplified installation.

Another advantage resides in employing a public switching telephone network to provide service to patients that do not or cannot receive broadband service.

Another advantage resides in providing A/V content on a storage medium to mitigate an amount of bandwidth required to present the content to the patient.

Still further advantages of the subject innovation will be appreciated by those of ordinary skill in the art upon reading and understand the following detailed description.

The innovation may take form in various components and arrangements of components, and in various steps and arrangements of steps. The drawings are only for purposes of illustrating various aspects and are not to be construed as limiting the invention.

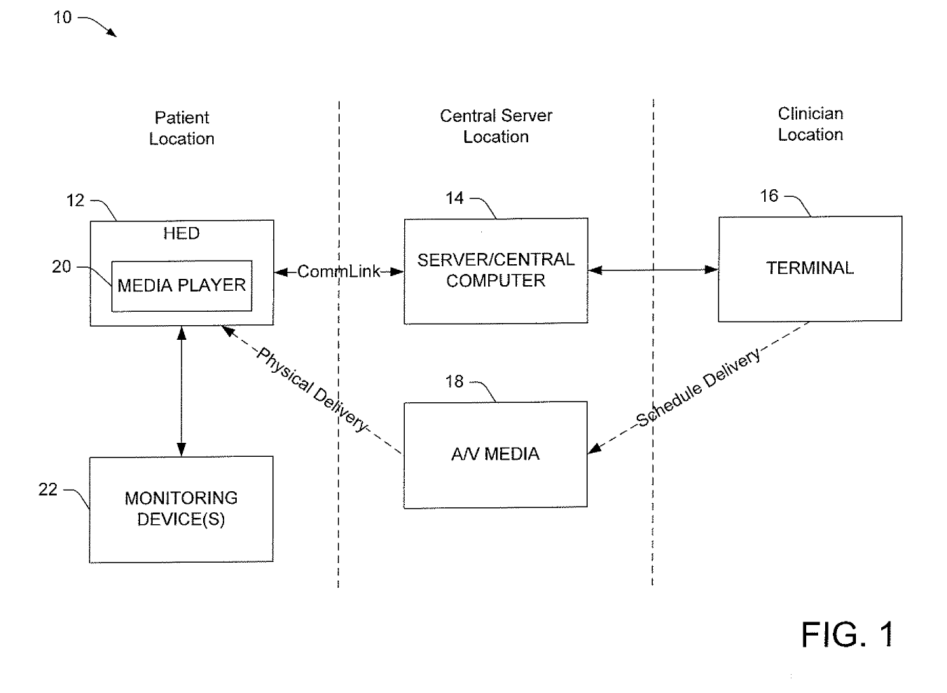

FIG. 1 illustrates a system for providing remote healthcare to a patient in his or her residence using low-cost alternative technologies to facilitate scheduling, delivering, and viewing of audio and/or video (A/V) content at the patient's residence or other remote location.

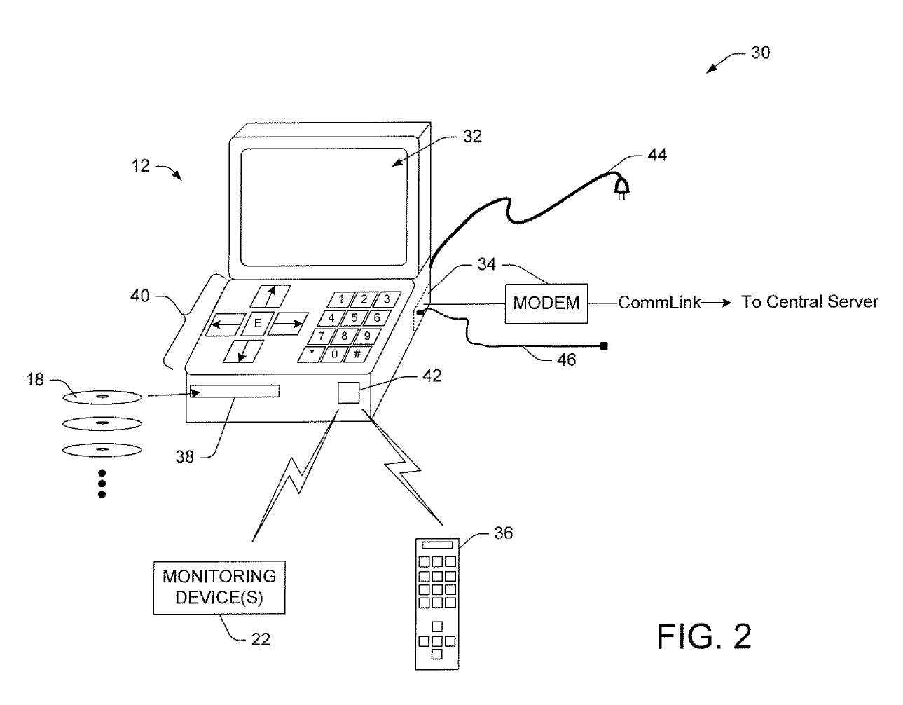

FIG. 2 is an illustration of a system for cost-efficient remote patient health monitoring, in accordance with various aspects.

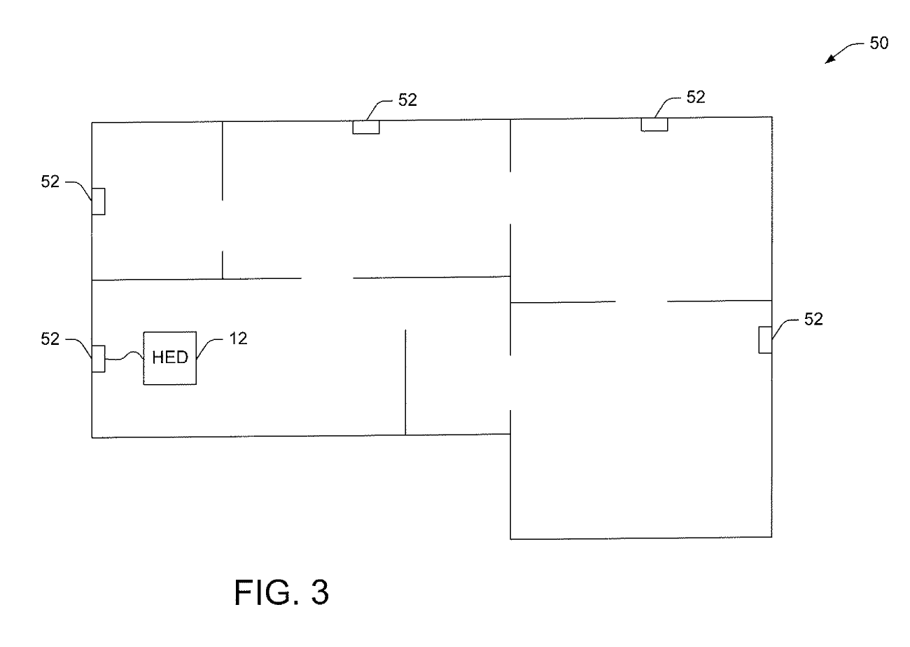

FIG. 3 is an illustration of a remote patient monitoring environment in which the subject innovation is employed, in accordance with various embodiments.

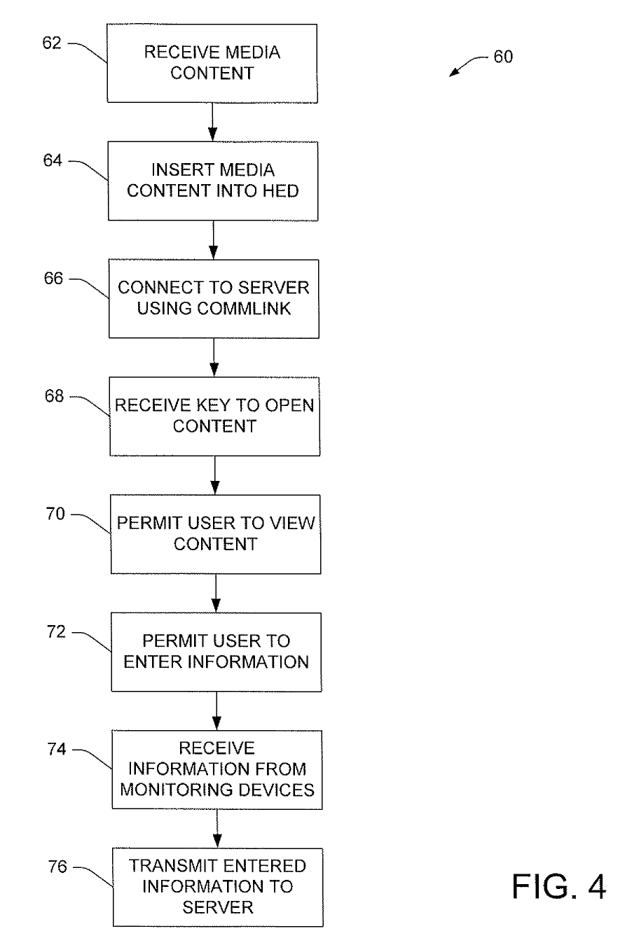

FIG. 4 illustrates a method of providing a low-cost remote monitoring system to a patient for viewing health-related media content and for providing patient status information to central service provider, in accordance with one or more embodiments.

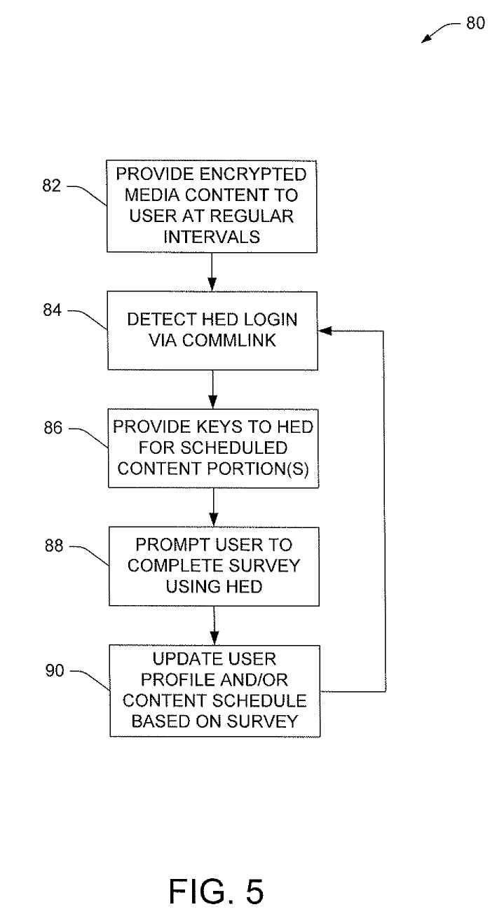

FIG. 5 illustrates a method of employing patient response information to update a content viewing schedule for the patient, in accordance with one or more features.

FIG. 1 illustrates a system 10 for providing remote healthcare to a patient in his or her residence using low-cost alternative technologies to facilitate scheduling, delivering, and viewing of audio and/or video (A/V) content at the patient's residence or other remote location. The system can be applied in the patient's home to run the patient's software application, and can be used in the management of chronic diseases. For instance, the system can be used to educate the patient on medical subjects including but not limited to: various disease descriptions and the desired behavior to mitigate their effects upon the patient; motivating the patient to improve such behavior; describing how to install, use, and troubleshoot the medical equipment installed in the patient's home or remote location; etc.

The system 10 comprises a home-end device (HED) 12 located at the patient's residence or other remote location, and that communicates bi-directionally with a server 14 at a central location, such as a healthcare provider's location. The HED 12 and the server 14 communicate, for instance, over a public switch telephone network (PSTN) communication line. The server 14 in turn is coupled to a terminal 16 that is employed by a clinician (e.g., a doctor, a nurse, or some other healthcare provider). The terminal 16 can be located at the healthcare provider location or remotely in another location. Additionally, communication between the server 14 and the terminal 16 can be wireless or wired, and can occur over an Internet/Ethernet connection or the like. The clinician (and/or the terminal 16) schedules delivery of A/V media 18 for the patient, which may comprise one or more DVDs with healthcare-related information stored thereon, and which can be stored at the healthcare provider location or some other storage facility. Once scheduled, the A/V media 18 is delivered to the patient's location (e.g., via mail or post, courier, etc.) for playing back to the patient using a media player 20 included in the HED 12. According to other embodiments, the media is provided to the patient at regularly-scheduled appointments. Additionally, the HED is operatively coupled (e.g., via wired or wireless communication links, such as Zigbee, Bluetooth, infrared, radio frequency, etc.) to one or more monitoring devices 22 that monitor a health status of the patient.

The A/V content, stored on a medium (e.g., DVD-ROM, CD, memory stick, floppy disk, or some other suitable medium), may be scheduled to be delivered at the time of installation of the HED and/or the monitoring devices, or at a later time. For instance, a clinician can order A/V content on a portable medium to be delivered to the patient's home or remote location. The system 10 provides for delivery of this content on a physical medium and by a physical delivery method (e.g., mail or post, courier, etc.). A/V content delivery over conventional communication links typically involves high bandwidth connections. Although A/V content can be delivered over any electronic communication link, using a deliverable media enables the communication link to the patient's HED to be of lower bandwidth than would otherwise be possible.

Additionally, scheduling and delivery of the A/V content can be incorporated into a healthcare plan for the patient. For instance, feedback from the patient can be obtained in a variety of ways, including verbal feedback received at an appointment with a clinician, feedback from surveys completed by the patient using the HED, etc. The feedback information can automatically trigger updates to the delivery and/or viewing schedules for the patient.

At installation, the A/V media 18 is installed in the proper location (e.g., a DVD drive or the like) for use in the HED. If media (e.g., DVDs, CDs, etc.) are later delivered to the patient, the patient receives a medium and places it in the proper location for use by the HED. The clinician can schedule replacement and/or updated audio-video content at a later time by scheduling delivery of additional or replacement A/V content, delivered in the same or similar manner After installation or delivery, the clinician can schedule a certain segment or portion of the audio-video content to be viewed by the patient. The patient receives notices on the HED that the patient has been requested to view the specified segment(s) (e.g., an LED that is illuminated to indicate that new content is available, etc.). The patient then uses the HED to start the viewing of the segment or portion of the A/V content that has been specified. The patient can also view segments of the A/V content at the patient's own initiative by using the HED to select the portion of content he desires from a menu of possible segments. In any case, the patient can be provided with a key or code that unlocks the scheduled portion of media content for viewing. The HED can notify the clinician, via the server and terminal, what A/V content the patient has viewed and when the patient viewed it, whether the clinician requested the viewing by the patient or the patient viewed the content of his own initiative. The clinician can also receive an indication that the patient has not watched the specified content within a pre-specified time period, which can be set by the clinician.

In accordance with various embodiments, The A/V media 18 comprises one or more of optical media, such as a CD-ROM or DVD, semiconductor memory (e.g., RAM, ROM), and magnetic media (e.g., disk, take, etc.). The communication link can be, for instance, a PSTN line, a cellular communication link, a 2-way pager link, and/or a broadband communication channel, such as DSL, cable, or wireless broadband. The HED 12 can include input devices such as a plurality of buttons that the patient depresses to enter information and/or select information presented to the patient, a touch panel screen for information entry, voice-activated entry etc. Additionally, the HED can include output components such as an LED or plasma screen, a CRT or LCD monitor, speakers, automated voice output, etc. In one embodiment, the HED is connected to the patient's television, which is used as an output component to present the A/V content to the patient. The media player 20 can include commercially available media players, such as a TV-DVD/CD player, a DVD/CD player with integrated display, a custom-designed player for optical, magnetic, or semiconductor media. Media player control can include optical control, such as by infrared remote control, or wired control. It will be appreciated that various embodiments can comprise numerous combinations of elements in order to facilitate reducing system cost and mitigating a dependency on broadband availability.

The central server 14 can include custom and/or off-the-shelf hardware. Customized software permits physical media delivery and tracking, patient content viewing specification, scheduling, and tracking, notice of a patient's failure to view specified content, notice to a patient of an impending content delivery, etc. The delivery scheduling method can include electronic communication, mail, phone communication, etc. The physical delivery method of the media can include mail, private delivery service, hand delivery, patient pickup (e.g., at the service provider's clinic or office), etc.

FIG. 2 is an illustration of a system 30 for cost-efficient remote patient health monitoring, in accordance with various aspects. Often, remote healthcare systems include numerous expensive components that add to system cost and complicate installation. For instance, a typical system may comprise a set-top box that connects to the patient's television, and a remote control that operates the set-top box. Additionally, such setups involve a cable modem, cables to connect the components, and/or an AB audio/video switch, infrared receiver, event waiting indicator, broadband service, and professional installation. In the illustrated embodiment, the system 30 combines the functionality of the foregoing components and services into a single home-end device (HED) 12, which is employed to provide a graphical user interface (GUI) 32 that presents videos, surveys, quizzes, messages, vital sign charts, etc., to the patient. Thus, the system 30 does not require the patient's television or monitor as a display device, which allows more freedom in the location of the HED within the home and prevents undesirable confusion for the patient when trying to switch between the normal TV/DVR video programs and the video content on presented by the HED. Additionally, the HED provides information related to patient responses, patient health status, etc., to clinical and/or administrative user interfaces using computer hardware (e.g., servers, computers, monitors (not shown) associated with clinical applications via a modem 34. According to an example, the modem is a v.92 modem, although other modems may be employed in conjunction with the various embodiments described herein. It will be appreciated that the modem may be integral to the HED in accordance with some embodiments, such that a user can plug a phone line 46 directly in to the HED and be ready to communicate with a centralized server.

Equipment such as the HED 12, A/V media 18, monitoring devices 22, and a remote control 36 for entering and/or selecting information into the HED can be shipped or otherwise delivered to the patient (e.g., by mail or post, courier, or some other means), as prescribed or otherwise directed by the service provider or clinician. The HED includes the GUI 32 for presenting information to the patient, and an integral or external modem 34 that provides a connection to a centralized server. The modem 34 utilizes a PSTN communication protocol or the like to generate a communication link over a telephone line at the patient's location, according to some aspects. The HED additionally includes a media player 38 that receives the A/V media 18 for presentation to a patient. According to one example, the A/V media is stored on a DVD ROM disc and the media player is a DVD player. According to another example, the media is stored on a memory stick and the media player comprises USB port into which the memory stick is inserted. Yet another example includes A/V media stored on a CD, and the media player comprises a CD player that reads information from the CD for presentation to the patient. It is to be appreciated that the storage medium on which the A/V media is stored may be any suitable storage medium, and the media player may accordingly include any suitable means for reading the A/V media from the storage medium for playback the patient.

The HED additionally comprises a plurality of buttons and/or keys 40 that the patient employs to enter information into the HED. For instance, the plurality of buttons can include a number of directional arrows (e.g., up, down, left, right, etc.) that the patient uses to navigate through information presented on the GUI, as well as an “enter” key that the patient depresses to select or enter information on the GUI for entry to the HED. According to another embodiment, the HED includes a numerical keypad, similar to that of a telephone, which the patient uses to enter numerical information. Yet another embodiment relates to a touchscreen GUI for user input. Additionally, the system 30 includes the remote control 36, which has a similar or identical plurality of keys 40, and the HED receives information from the remote control via a wireless component 42. Optionally, the input buttons or keys can be located only on the remote. For instance, the wireless component can include an infrared (IR) and/or radio frequency (RF) component that receives one or more of IR and RF signals from the remote control. Additionally, the wireless component can include a Bluetooth, Zigbee, or other component and can receive information using associated communication protocols from one or more monitoring devices 22. For example, the monitoring devices 22 can include a digital scale, a blood pressure (BP) monitor, a pulse oximeter, a glucometer, a rhythm strip recorder, or any other suitable patient monitoring devices that measure a state of the patient and transmit information related thereto to the HED for transmission to the service provider and/or clinician.

In one embodiment, the HED is a flat screen monitor with a built-in DVD drive, a built-in telephone modem, and a built-in communication module if wireless patient modules are part of the system. Input buttons can then be located on the remote, a touch screen, or as virtual buttons displayed on the GUI. Alternatively, a limited number of buttons can be arranged in columns along sides of the GUI. In this manner, the HED has only two cords, a power cord 44 that terminates with a standard and easily recognizable wall plug, and a telephone cord 46 that ends with a standard plug for a telephone jack. Additionally or alternatively, the HED has a telephone jack, coupled to an internal modem 34, into which a user can insert a telephone cord, and then can insert the other end of the cord into a wall-mounted telephone jack.

According to a general example, the system 30 exhibits reduced overall system cost by replacing the set-top box, the patient's television the cable modem, cables to connect the components, AB audio/video switch, separate infrared receiver, event waiting indicator, broadband service, professional installation, etc., with a less expensive hardware configuration, capable of presenting the same (or similar) patient interface. The equipment is “plug-and-play,” meaning that professional installation is not required, and communicates with the clinical end via a standard telephone line already present in the patient's home (therefore eliminating the cable or other broadband subscription and associated monthly service charge). Video can be provided on DVD disks and video program material is periodically updated by sending new DVD disks to the patient's home. A video monitor, DVD player, and interface are part of the HED, and can be either integrated or separate off-the-shelf components. Patient control and/or input occurs by touchscreen, buttonpad, mouse, or custom tablet.

In some embodiments, the GUI and media player are an integral off-the-shelf device, such as a portable DVD player that is plugged into the HED, which provides the remaining functionality (e.g., communication link to the central server, wireless communication with the remote and/or monitoring devices, etc.)

Data transfer is executed using small packets capable of being delivered over telephone lines at reasonable and/or conventional data rates. Video need not be transferred in this manner because it is present on a DVD disc. The system 30 controls the media player to call up DVDs at the appropriate time and with the appropriate controls. For an example, a particular video segment is scheduled for the patient to view, and the patient starts the video presentation when the patient chooses. In the event that the media content is not already inserted into the media player, the HED can prompt the user to insert the media content. Automatic control of the media player can be performed using wired or wireless means, for example using the IR signals from a controlling unit to remotely control the media player. Additionally, A/V media is refreshed from time to time, such as by sending out new discs or other storage media as needed. In this manner, the system 30 leverages off-the-shelf, high volume, readily available, and competitively priced components (such as DVD players, LCD or CRT displays, etc.). Additionally or alternatively, the HED includes custom hardware, software, and/or firmware.

Accordingly, in one embodiment, the system 30 facilitates providing an interface including a display specific for patient monitoring, which does not rely on broadband or the patient's existing television. The system 30 also provides for data transfer over a telephone line instead of broadband, and video delivery via DVD installed with the system and updated by periodic mailing to the patients home. Moreover, DVD playback is controlled by the system, and the HED serves as data hub for transferring messages, surveys, quizzes, and vital sign data from the patient's home to the clinical application.

In one embodiment, the HED 12 is a self-contained unit that is user friendly, such as a digital picture frame/display or portable DVD player. Since many TVs are now a part of home entertainment systems with complex cabling, requiring highly paid professionals to modify the cabling to accommodate an additional system, complex setup issues are mitigated by providing the self-contained HED. The GUI display 32, such as an LCD or the like, is connected with (or easily cabled to) which includes the DVD ROM player 38, a computer controller (not shown) such as a processor and associated memory, the modem 34, the wireless component 42 for receiving signals from wireless physiological parameter monitors 22, and an input device such as the remote control 36, the small keypad 40, or a touchscreen. The HED has one input connection for a regular phone line and another power connection for electrical power. In one embodiment, the HED includes a picture frame and digital picture display that displays digital photographs when not in use for medical purposes and is easily switched over to its medical applications at the touch of a button.

In another embodiment, the HED includes A/V ports (e.g., typically red, yellow, and white color-coded A/V connectors) (not shown) that the patient may use to connect the HED to corresponding ports on the patient's TV should the patient so desire. In this case, the patient is provided with the option of performing a third connection by plugging the HED into the A/V jacks, which are often conveniently located on the front of more modern television sets, should the patient desire a larger display than is provided on the HED.

The patient periodically receives the DVD 18, for instance in the mail or during a doctor's visit. According to an example, a single DVD carries approximately 90 days worth of educational programming However, it will be appreciated that various DVDs have different storage capacities, and that more or fewer educational programs may be stored on a single DVD in accordance with healthcare program constraints and as a function of DVD capacity. Periodically, the system 30 dials in to the hospital or medical center to receive instructions, report physiological parameter readings, receive e-mail messages for the patient, and the like. Unlike a typical DVD player, the system controls the programming content that can be presented at any given time. For example, once a day, the system permits the viewer to watch the next scheduled video segment(s). In this example, the HED auto-connects to the server, receives decryption keys for a specified video segment, and then alerts the patient that a video is ready for viewing. The segment(s) are read from the DVD disk on a designated schedule. The programming can also include a survey which enables a patient to answer questions about the video. Based on the scoring of this survey, the medical center may send control signals to the unit such that at the next viewing, a remedial segment is played, an advanced segment is played, one of the prior video segments is played, or the like.

A well-being survey can be presented to the patient each morning or more often, during the day. This survey asks the patient general questions about how the patient is feeling. The answers to these questions are transmitted via a modem and phone line to the medical center where they will be computer reviewed using a series of rules. If the answers indicate that medical assistance should be provided, a nurse on call or other medical professional is alerted and appropriate instructions are returned promptly to the patient. The patient's HED controls the modem to hold the communication line open for a period of time after reporting these survey results. If the rules-based analysis indicates that there is a medical problem, the computer at the hospital end can instruct the patient's HED control computer to hold the connection open longer while a medical professional is consulted.

By providing an integrated HED with only power and telephone inputs, the HED can be readily carried by the patient to substantially any room in the home or other remote location. The GUI can be viewed like a TV, held like a book, or the like. The GUI can also be held as close to or as far away from the patient as the patient's eyesight may dictate. Moreover, the patient can take the HED when visiting friends or relatives down the street or across the country. For instance, the GUI portion of the HED can be folded down into a closed position against the keypad 40 (e.g., such as is common with portable DVD players, laptops and the like). In other embodiments, the GUI portion is collapsible, retractable, and/or expandable, further reducing device size and increasing portability. The HED can be made even more portable using rechargeable and cell phone technologies. Still furthermore, the HED can be equipped with a reset button (not shown) that the patient can press when plugging the HED in to a new phone line. Depressing the reset button causes the HED to connect to a registration server to alert the server to re-identify the phone number from which the HED is dialing in. The HED can then open a communication link with the service provider server as usual.

FIG. 3 is an illustration of a remote patient monitoring environment 50 in which the subject innovation is employed, in accordance with various embodiments. The environment 50 may be, in some aspects, a patient's residence or home, and includes a plurality of rooms. The environment 50 includes one or more phone jacks 52 into which the patient plugs an HED 12 during a remote monitoring session or the like. For instance, the patient places the HED in a room in which the patient desires to carry out the monitoring session or to view A/V material, and plugs the HED into a phone jack. The HED is powered by plugging into a wall outlet or by battery, or both. The patient then turns on the HED and inserts the A/V media to be viewed. Should the patient so choose, the patient can move the HED into another room at the patient's convenience and plug into a phone jack there to continue the remote monitoring session.

In one embodiment, the patient receives a DVD containing several educational videos and the like. For instance, the patient can receive a DVD containing approximately 90 videos of approximately 5-10 minutes in length, and can view a new video each day for approximately three months, at which time the patient receives a new DVD (e.g., via mail, post, courier, etc.). A/V media is encrypted to prevent unauthorized viewing. When the patient plugs in and logs on to the service provider network, the patient's HED receives keys that unlock scheduled content and permit the patient to view the scheduled content. For example, the patient can log into the system (e.g., by plugging in to the telephone line and optionally entering user identification information when prompted, etc.) and the keys (e.g., a decryption codec or the like) can be downloaded to the HED to permit the patient to view the content scheduled for the given day or session. According to another example, the patient can select a video or other media that the patient would like to view and can request that the video be made available. In such a case, the service provider server can transmit the decryption key(s) required for the requested video to the patient's HED to unlock the video for viewing. In this manner, proprietary content can be protected by the service provider and/or manufacturer until the user is authorized to view the content. Additionally, restricting access to the content helps the patient remain focused on the healthcare plan as provided, rather that pursuing his own objectives, which can distract the patient and detract from the goals of the healthcare plan generated by the healthcare provider.

FIGS. 4-5 illustrate one or more methods related to providing a low-cost remote monitoring system that communicates with a centralized server using a PSTN communication link in order to reduce system setup and operation complexity for a patient, in accordance with various features. While the methods are described as a series of acts, it will be appreciated that not all acts may be required to achieve the described goals and/or outcomes, and that some acts may, in accordance with certain aspects, be performed in an order different than the specific orders described.

FIG. 4 illustrates a method 60 of providing a low-cost remote monitoring system to a patient for viewing health-related media content and for providing patient status information to central service provider, in accordance with one or more embodiments. At 62, a patient receives media content, such as a DVD ROM or the like comprising health-related video and/or audio information for viewing by the patient. The patient receives the content in the mail, via courier or parcel service, hand delivery, by picking up the content at a service provider location such as a warehouse or clinic, or by any other suitable means or method. At 64, the patient inserts the media into the HED for viewing. That is, if the media is stored on a DVD, then the patient inserts the media into a DVD player associated with or integral to the HED. However, it will be appreciated that other media storage types (e.g., CD, memory stick, magnetic tape, floppy disk, smart card, mini disc, memory card, etc.) are contemplated, and the patient can insert such storage media into an appropriate media player or reader for playback of the content.

At 66, the patient connects to the service provider's server using a communication link generated by the HED. The communication link can be automatically opened by the HED when the user connects the HED to a phone jack, and/or can be initiated upon the patient entering user ID information into the HED. At 68, one or more decryption keys are received at the HED to unlock one or more videos or surveys for patient viewing. For instance, if the patient is scheduled to view one or more videos on a given day, then upon logging on to the system, the decryption keys for the relevant portion of the content on the DVD are provided to the patient's HED. According to another example, the HED and/or the server track patient viewing activity, and the HED is provided with decryption keys for a next unviewed video in a series of videos.

At 70, the patient is permitted to view the scheduled content. According to an example, videos may be marked with a watermark or other signal that prompts the HED to record and/or transmit an indication that the video has been viewed by the patient.

Additionally, at 72, other information is entered into the HED and transmitted to the server for evaluation by a clinician. For instance, entered information can be user-entered information, such as through a remote control associated with the HED, keys or a touchscreen on the HED, etc. Additionally or alternatively, entered information can include information received from one or more patient monitoring devices (e.g., a scale, a BP monitor, a blood-glucose monitor, an oximeter, a rhythm strip recorder, or some other suitable patient status monitoring device, at 74. The HED then transmits entered information to the server, at 76. By providing the media content on a storage medium that is inserted into the HED, a need for a high-speed broadband connection is mitigated, thus permitting the HED and server to communicate using a less expensive alternative communication link, such as the PSTN communication link, to transmit smaller packets of information (e.g., monitoring device measurement information, decryption key information, etc.).

FIG. 5 illustrates a method 80 of employing patient response information to update a content viewing schedule for the patient, in accordance with one or more features. At 82, encrypted media content is provided to a patient at regular or semi-regular intervals. For instance, a patient can receive a DVD or other storage medium comprising A/V media content monthly, weekly, quarterly, etc., with ample content thereon to facilitate daily, weekly, etc., viewing on portions of the content. The patient's HED is detected by a centralized service provider server upon login to a communication link with the server, which is a PSTN communication link in some embodiments, at 84. At 86, decryption keys for one or more scheduled videos are provided by the server to the HED over the communication link, and the patient is permitted to view the scheduled content.

At 88, the patient is prompted to complete a survey related to the viewed content. For example, the patient can be prompted to rate the video(s) for information content, ease of understanding, relevance to the patient's present condition, etc. Additionally, the patient can be prompted to enter objective information, which can be automatically entered from monitoring devices connected to the HED and/or can comprise patient diet information and the like, as well as subjective information (e.g., how the patient feels, whether the patient has experienced specified symptoms, etc.). In response to the entered information, a clinician can update the patient's content-viewing schedule, at 90. For example, the patient may enter information that renders one or more scheduled videos less relevant than other scheduled videos, and the clinician can redesign the patient's viewing schedule with preference given to the more relevant video content. Additionally, the method facilitates reducing system complexity for the user because all information transfer between the server and the HED occurs over a PSTN connection, so the user does not need to maintain an expensive broadband service. Furthermore, the method facilitates providing service to users that cannot obtain broadband connections due to geographical or other impediments.

Having thus described the preferred embodiments, the invention is now claimed to be:

1. A system (10, 30) for remotely monitoring a patient, including:
a home-end device HED (12) that periodically connects to a healthcare service provider server (14) over a communication link and receives at least one decryption key;
a media player (20, 38) that receives a storage medium (18) containing encrypted audio/video (A/V) content, a scheduled portion of which is unlocked by the at least one decryption key; and
a power cable connection.

2. The system according to claim 1, wherein the communication link is a public switching telephone network (PSTN) communication link

3. The system according to claim 1, wherein the media player (20, 38) is at least one of a DVD player or media player with a USB port, and the storage medium 18 is at least one of a DVD ROM disk or a USB memory stick.

4. The system according to claim 1, further including a graphical user interface (GUI) (32) that presents the A/V content to the patient.

5. The system according to claim 1, further including an input device (32, 36, 40) that is employed by the patient to input information to the HED (12),wherein the input device is at least one of a touchscreen (32), a remote control (36), or a keypad (40).

6. The system according to claim 1, further including a monitoring device (22) that measures a health state of the patient and wirelessly transmits the health state information to a wireless component (42) in the HED (12).

7. The system according to claim 1, wherein the decryption key is provided to unlock the scheduled portion of the A/V content according to a schedule that is part of a healthcare plan for the patient.

8. The system according to claim 1, wherein portions of the A/V content that are not unlocked by the received decryption key are not viewable by the patient until respective decryption keys there for are received.

9. The system according to claim 1, wherein the server (14) includes:
a routine or means (82) for periodically providing encrypted media content to the patient;
a routine or means (84) for detecting the HED (12) upon login over the communication link;
a routine or means (86) for providing decryption keys to the HED (12) for a scheduled portion of A/V content;
a routine or means (88) for prompting a patient to complete a survey by entering information into the HED (12); and
a routine or means (90) for updating a content-viewing schedule for the patient based on the survey.

10. A method for providing the system of claim 1, comprising:
receiving healthcare-related media content on a storage medium (18);
inserting the storage medium (18) into the media player (20, 38) of the HED (12);
establishing a communication link with the server;
receiving a decryption key for a scheduled portion of the media content;
displaying scheduled content to the patient and receiving patient-entered information; and
transmitting the patient-entered information to the server (14) for review by a clinician.

11. A home-end device (HED) (12) comprising, in a common housing:
a video display (32);
a media player (20, 38) that plays media (18) for display on the display (32); and
a telephone modem (34) for receiving communications via a public switching telephone system.

12. The HED (12) according to claim 11, further including:
a power cord (44) extending from the HED (12); and
a telephone cord (42) for connecting with a telephone jack.

13. The HED (12) according to claim 11, wherein the common housing has a form of a framed picture that can be held by a patient for easy viewing.

14. The HED (12) according to claim 11, wherein the media (18) is encoded or encrypted, and further including:
a means or routine (66) for connecting to a server (14) via the modem (34); and
a means or routine (68) for receiving a key to release one or more selected portions of video programming from the media (18), the released video programming being displayed on the display (32).

15. A method of providing a remote patient healthcare monitoring and education system, including:
instructing the patient to connect an HED (12) to a telephone line and a power source;
physically providing encrypted healthcare-related media content to a patient on a physical medium (18);
instructing the patient to insert the media content physical medium (18) into a media player (20, 38) associated with the HED (12);
generating a communication link between the HED (12) and a centralized server (14) over the telephone line;
providing one or more keys that unlock a scheduled portion of the media content to the HED (12); and
displaying the scheduled portion of the media content to the patient.

16. The method according to claim 15, further including:
delivering another encrypted healthcare-related media content physical medium (18) to the patient using at least one of mail, post, courier, or parcel service.

17. The method according to claim 15, further including:
prompting the patient to enter information responsive to survey questions into the HED (12); and
transmitting patient responses to the centralized server (14) for review by a clinician.

18. The method according to claim 17, further including employing a public switching telephone network to deliver at least one of keys to the HED (12) and patient responses to the server (14).

19. The method according to claim 18, further including adjusting a healthcare regimen for the patient as a function of the patient responses and adjusting a content-viewing schedule for the patient as a function of the patient responses.

20. A processor or computer-readable medium programmed to perform the method of claim 15.

21. A remote healthcare patient education system, including:
means for scheduling physical delivery of healthcare-related A/V media content to a remote patient;
means for providing a PSTN communication link between an HED (12) at the patient location and a centralized server (14);
means for providing at least one decryption key to the HED (12);
means for displaying decrypted media content to the patient according to a viewing schedule;
means for receiving feedback related to the displayed media content from the patient; and
means for adjusting the predefined viewing schedule as a function of the feedback.

22. The system according to claim 21, wherein received feedback from the patient is employed by the means for scheduling to update a delivery schedule for delivering A/V media content to the patient.
